(19) United States
(12) Patent Application Publication
(10) Pub. No.: US 2026/0072493 A1
(43) Pub. Date: Mar. 12, 2026

(54) ENERGY MANAGEMENT FOR INFRASTRUCTURE

(71) Applicant: Dell Products L.P., Round Rock, TX (US)

(72) Inventors: MAXIM BALIN, Gan-Yavne (IL); SHLOMI ZARETSKI, Beer Sheva (IL); DANIEL OSTROVSKY, Beit Arye (IL)

(21) Appl. No.: 18/882,924

(22) Filed: Sep. 12, 2024

(51) Int. Cl. G06F 1/3234

(52) U.S. Cl. CPC G06F 1/3278; G06F 1/3243; G06F 1/3275

(57) ABSTRACT

Methods and systems for managing operation of a deployment are disclosed. The operation may be managed by determining whether an edge device is operating in an undesired manner. The determination may be made by determining a health state and/or a security state of the edge device. The health state and/or the security state may be determined by obtaining at least one power consumption level of the edge device and classifying an operational state of the edge device. If the edge device is determined to be operating in the undesired manner, the operation of the edge device may be remediated to improve a provision of computer implemented services.

### FIELD

Embodiments disclosed herein relate generally to infrastructure management. More particularly, embodiments disclosed herein relate to power consumption management.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIGS. 2A-2D show interaction diagrams illustrating operation of a system in accordance with an embodiment.

FIG. 3 shows a flow diagram illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to managing operation of a deployment. The operation may be managed by determining whether an edge device is operating in an undesired manner. The edge device may be determined to be operating in an undesired manner by (i) monitoring a power consumption level of the edge device, (ii) determining, using at least the power consumption level, an operational state of the edge device, and (iii) using the operational state and the at least the power consumption level to determine a health state and/or a security state of the edge device.

The power consumption level may be monitored by measuring at least a current power consumption level. The current power consumption level may be stored in a repository of previous power consumption levels of the edge device. The operational state may be determined by using at least the current power consumption level to identify an operational state of the edge device. The current power consumption level may be averaged with at least one previous power consumption level from the repository to obtain an average power consumption level. The operational state of the edge device may be typified as, for example, running, idle, paused, stopped, under maintenance, etc.

The health state and/or the security state may be determined by using the operational state and at least the power consumption level to identify a behavior by the edge device. The power consumption level may include the average power consumption level of the edge device. The health state may first be identified using the operational state and/or the average power consumption level. Then, the security state may be identified using the health state and/or the average power consumption level.

Based on determination of the health state and/or the security state, a determination may be made whether the edge device may be operating in the undesired manner. If the edge device is determined to be operating in the undesired manner, the operation of the edge device may be remediated. Remediating the operation of the edge device may include (i) constraining operation of a portion of the edge device, (ii) reinitializing the operation of the portion of the edge device, and/or (iii) disabling use services of the portion of the edge device.

In an embodiment, a method for managing operation of a deployment is disclosed. The method may include (i) measuring power consumption levels of entities hosted by an edge device of the deployment, (ii) inferring, using the power consumption levels, an operational state of at least a portion of the edge device, (iii) making a determination regarding whether the operational state indicates that the at least the portion of the edge device is operating in an undesired manner, (iv) in a first instance of the determination where the at least the portion of the edge device is operating in the undesired manner: (a) updating operation of at least the portion of the portion of the edge device to remediate the undesired manner of operating, and (b) providing, using the updated operation of the at least the portion of the edge device, computer implemented services.

Measuring the power consumption levels of the entities may include (i) obtaining at least a central processing unit usage of the entity, (ii) obtaining at least a memory usage of the entity, (iii) obtaining at least a network traffic usage of the entity, and (iv) obtaining, using the at least the central processing unit usage, the at least the memory usage, and the at least the network traffic usage, a power consumption level of the power consumption levels for the entity.

Obtaining the power consumption level may include obtaining a weighted sum of the at least the central processing unit usage, the at least the memory usage, and the at least the network traffic usage.

Inferring, using the power consumption levels, the operational state of the at least the portion of the edge device, for an entity of the entities, may include: (i) comparing the power consumption level to a nominal power consumption level for a type of the entity, and (ii) concluding that the entity is in an undesired operating state, in an instance of the comparing where the power consumption level and the nominal power consumption level different by a threshold level.

The nominal power consumption level may be based on an average of power consumption levels from a cohort of entities that are of the type of the entity over a period of time.

The power consumption level may be averaged over a duration of time to reduce impacts of transient changes in the power consumption level.

The nominal power consumption level may be adaptive to minimize a likelihood of assignment of the operational state that does not accurately reflect historic operation of the entity.

Updating the operation of the at least the portion of the portion of the edge device to remediate the undesired manner of operating may include constraining operation of the at least the portion of the portion of the edge device.

Updating the operation of the at least the portion of the portion of the edge device to remediate the undesired manner of operating may include reinitializing the at least the portion of the portion of the edge device.

Updating the operation of the at least the portion of the portion of the edge device to remediate the undesired manner of operating may include disabling use services provided by the at least the portion of the portion of the edge device.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

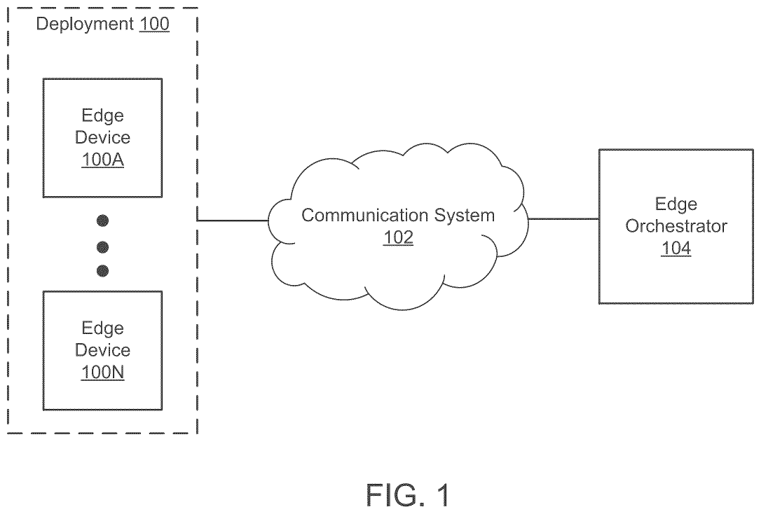

Turning to FIG. 1, a system in accordance with an embodiment is shown. The system may provide any number and types of computer implemented services (e.g., to user of the system and/or devices operably connected to the system). The computer implemented services may include, for example, data storage service, instant messaging services, etc.

To provide the computer implemented services, an edge device of a deployment may assign at least one task be performed by an entity of the edge device. The entity may include at least one container, at least one virtual machine, at least one application, etc. The at least one task may include running applications, hosting web services, running databases, performing data analysis, etc.

To perform the at least one task, the edge device may allocate power to the entity, based on a power requirement of the entity, by allocating hardware resources. The hardware resources may include central processing unit (CPU) resources, memory, network interfacing, etc. The hardware resources may be allocated to enable performance of the task by the entity.

As the entity performs the task, the entity may become compromised by malware introduced by a malicious actor. The malware may include crypto-mining malware, denial of service malware, polymorphic malware, etc. As a result, the power requirement of the entity may become irregular and/or erratic. Because the power requirement may become irregular and/or erratic, performance of the computer implemented services may be impacted.

In general, embodiments disclosed here relate to systems and methods for managing operation of a deployment. The operation may be managed by monitoring for a power consumption level by entities to perform a workload on an edge device. The entities may include at least one microservice, at least one virtual machine, at least one application, etc. The workload may include at least one task, at least one process, at least one computational activity, etc.

For an entity of the entities, obtaining the power consumption level of the workload may include obtaining at least a central processing unit (CPU) usage, at least a memory usage, and/or at least a network traffic usage. Once the at least the central processing unit (CPU) usage, the at least the memory usage, and/or the at least the network traffic usage are obtained, a weighed sum may be performed. The weighted sum may include performance of summation that includes a rate of the power per CPU usage, the rate of the power per memory usage, and/or the rate of the power per network usage.

From the weighted sum, the power consumption level may be obtained. To refine the power consumption level, transient changes in power consumption may be removed to obtain an average power consumption level. The average power consumption level may be obtained by computing an arithmetic mean using the power consumption level along with at least a second power consumption level.

The average power consumption level may be compared to a nominal power consumption level. The nominal power consumption level may be a standard and/or expected power consumption level by the entity. The nominal power consumption level may be adaptive to minimize a likelihood of assignment of the operational state that does not accurately reflect historic operation of the entity.

The average power consumption level may be compared to the nominal consumption level by measuring whether the average power consumption level and the nominal power consumption level are different by at least a threshold value. If the average power consumption level and the nominal power consumption level are different by the at least the threshold value, then the entity may be operating in an undesired operating state. Otherwise, if the average power consumption level and the nominal power consumption level are not different by the at least the threshold value, then the entity may not be operating in the undesired operating state.

If the entity is operating in the undesired operating state, one or more actions may be taken to remediate the undesired operating state. The remediation may include (i) constraining operation of a portion of the edge device, (ii) reinitializing the operation of the portion of the edge device, and/or (iii) disabling use services of the portion of the edge device. By performing the remediation, a likelihood of provision of the computer implemented services by the edge device may be improved.

To provide the above noted functionality, the system may include deployment 100, and edge orchestrator 104. Each of these components is discussed below.

Deployment 100 may include any number of edge device 100A-100N. The any number of edge devices 100A-100N may provide computer implemented services. The computer implemented services may be provided by performing, by entities, a workload. The entities may include at least one microservice, at least one virtual machine, at least one application, etc. The workload may include at least one task, at least one process, at least one computational activity, etc.

For an entity of the entities, the any number of edge device 100A-100N may obtain a power consumption level of the workload. The any number of edge device 100A-100N may obtain the power consumption level by measuring the at least the central processing unit (CPU) usage, the at least the memory usage, and/or the at least the network traffic usage. Once the at least the central processing unit (CPU) usage, the at least the memory usage, and/or the at least the network traffic usage, a weighed sum may be performed. The weighted sum may include the rate of the power per CPU usage, the rate of the power per memory usage, and/or the rate of the power per network usage. The power consumption level may be sent by the any number of edge device 100A-100N to edge orchestrator 104.

Edge orchestrator 104 may receive the power consumption level from the any number of edge device 100A-100N. Edge orchestrator 104 may use the power consumption level to determine if the entity is operating in the undesired operating state. To determine if the entity is operating in the undesired operation state, edge orchestrator 104 may obtain an average power consumption level of the entity. Edge orchestrator 104 may obtain the average power consumption level by obtaining, from the any number of edge device 100A-100N, at least a second power consumption level, and performing an arithmetic mean using the power consumption level and the at least the second power consumption level. The second power consumption level may be a historical power consumption level of the any number of edge device 100A-100N. By performing the arithmetic mean, the transient changes may be removed between the power consumption level and the at least the second power consumption level.

Edge orchestrator 104, using the average power consumption level, may perform a comparison with the nominal power consumption level. The nominal power consumption level may be the standard and/or the expected power consumption level by the entity. The nominal power consumption level may be adaptive to minimize the likelihood of assignment of the operational state that does not accurately reflect the historic operation of the entity.

Edge orchestrator 104 may perform the comparison by measuring whether the average power consumption level and the nominal power consumption level are different by at least the threshold value. If the average power consumption level and the nominal power consumption level are different by the at least the threshold value, then the entity may be operating in an undesired operating state. Otherwise, if the average power consumption level and the nominal power consumption level are not different by the at least the threshold value, then the entity may not be operating in the undesired operating state.

If edge orchestrator 104 determines that the entity may be operating in the undesired operating state, then edge orchestrator 104 may perform an action to remediate operation of the edge device. The remediation may include (i) constraining operation of a portion of the edge device, (ii) reinitializing the operation of the portion of the edge device, and/or (iii) disabling use services of the portion of the edge device. By performing the remediation, edge orchestrator 104 may improve the likelihood of the provision of the computer implemented services by the edge device.

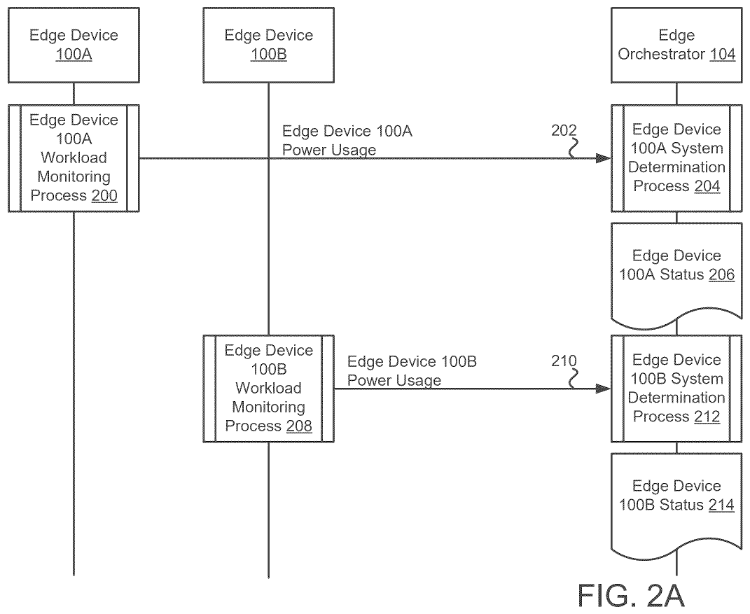

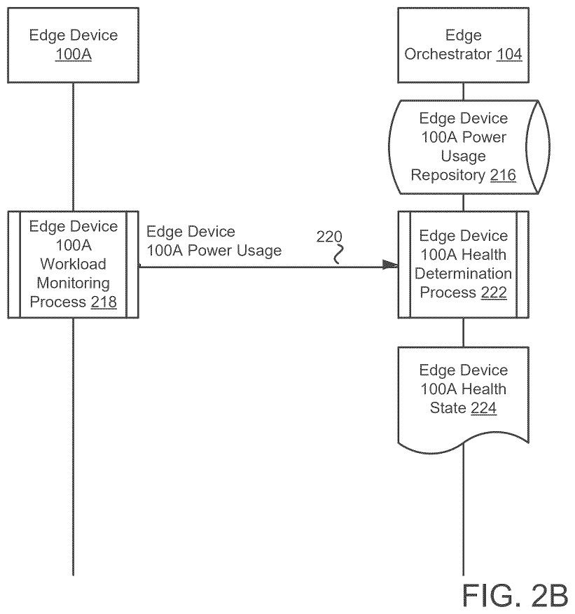

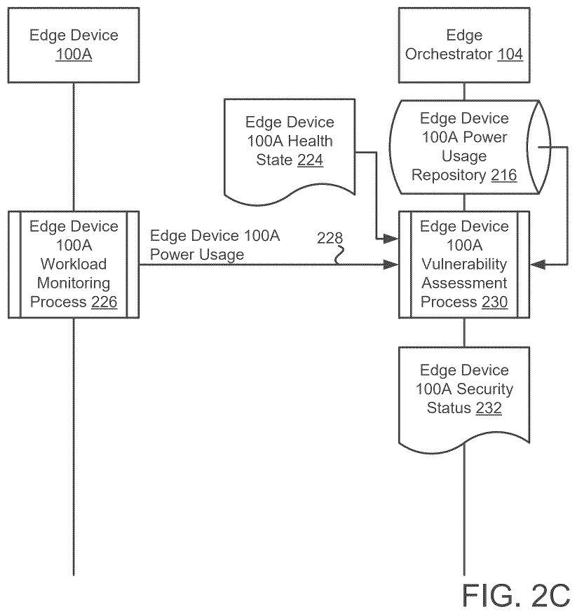

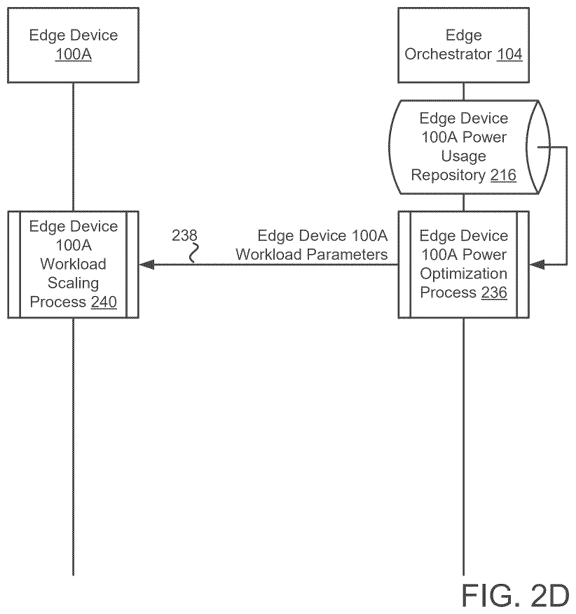

While providing their functionality, any of deployment 100 and edge orchestrator 104 may perform all, or a portion, of the flows and methods shown in FIGS. 2A-2D.

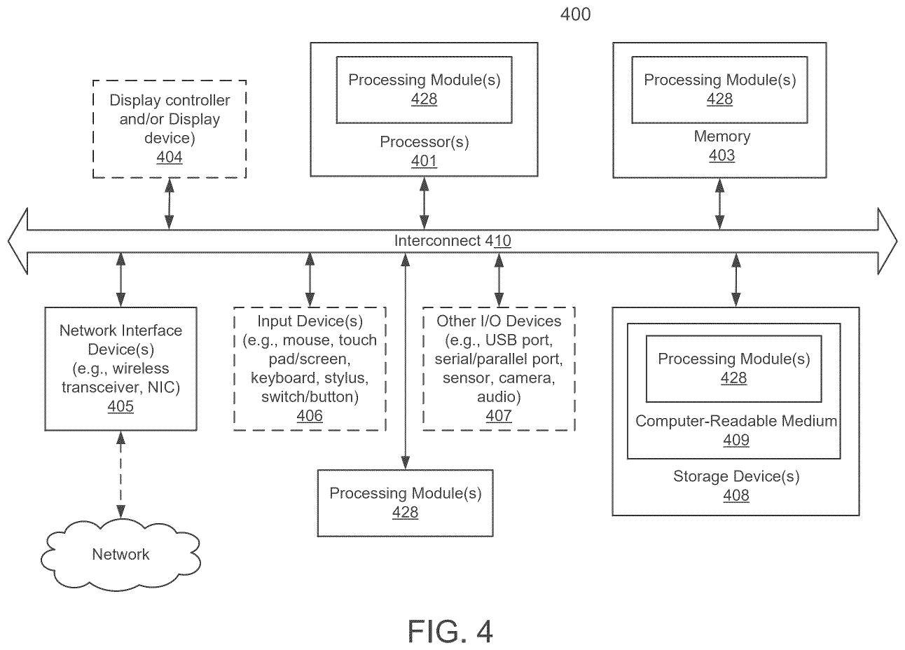

Any of (and/or components thereof) deployment 100 and edge orchestrator 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 102. In an embodiment, communication system 102 includes one or more networks that facilitate communication between any number of components. The networks may include wired networks and/or wireless networks (e.g., and/or the Internet). The networks may operate in accordance with any number and types of communication protocols (e.g., such as the Internet protocol).

While illustrated in FIG. 1 as including a limited number of specific components, a system in accordance with an embodiment may include fewer, additional, and/or different components than those components illustrated therein.

To further clarify embodiments disclosed herein, interactions diagrams in accordance with an embodiment are shown in FIGS. 2A-2D. These interactions diagrams may illustrate how data may be obtained and used within the system of FIG. 2A-2D.

In the interaction diagrams, processes performed by and interactions between components of a system in accordance with an embodiment are shown. In the diagrams, components of the system are illustrated using a first set of shapes (e.g., 206, 214, etc.), located towards the top of each figure. Lines descend from these shapes. Processes performed by the components of the system are illustrated using a second set of shapes (e.g., 200, 204, etc.) superimposed over these lines. Interactions (e.g., communication, data transmissions, etc.) between the components of the system are illustrated using a third set of shapes (e.g., 202, 210, etc.) that extend between the lines. The third set of shapes may include lines terminating in one or two arrows. Lines terminating in a single arrow may indicate that one way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the interaction labeled as 202 may occur prior to the interaction labeled as 210. However, it will be appreciated that the processes and interactions may be performed in different orders, any may be omitted, and other processes or interactions may be performed without departing from embodiments disclosed herein.

Turning to FIG. 2A, a first interaction diagram in accordance with an embodiment is shown. The first interaction diagram may illustrate data used in and data processing performed in determining a status of at least one edge device.

To determine the status for the at least one edge device, edge device 100A workload monitoring process 200 may be performed. During edge device 100A workload monitoring process 200, at least one distribution agent of edge device 100A may measure a power consumption level of entities that perform a workload. The entities may include at least one microservice, at least one virtual machine, at least one application, etc. The workload may include at least one task, at least one process, at least one computational activity, etc. The distribution agent may be a component of edge device 100A that performs load balancing, resource management, task scheduling, etc.

For an entity of the entities, the distribution agent may measure the power consumption level by obtaining at least a central processing unit (CPU) usage, at least a memory usage, and/or at least a network traffic usage. Once the at least the central processing unit (CPU) usage, the at least the memory usage, and/or the at least the network traffic usage, a weighed sum may be performed. The weighted sum may include a rate of the power per CPU usage, the rate of the power per memory usage, and/or the rate of the power per network usage.

Once the power consumption level is obtained from the weighted sum, the power consumption level may be transferred to edge orchestrator 104. For example, at interaction 202, the power consumption level of edge device 100A may be transferred to edge orchestrator 104. The power consumption level of edge device 100A may be transferred via a data stream, message queues, an application programming interface (API), etc.

Once the power consumption level is received by edge orchestrator 104, edge device 100A system determination process 204 may be performed. During edge device 100A system determination process 204, the power consumption level may be used to edge device 100A status 206. To determine edge device 100A status 206, edge orchestrator 104 may compare the power consumption level to at least one threshold level. Depending on a magnitude of the power consumption level, edge orchestrator 104 may determine if the entity of edge device 100A is running, idle, paused, stopped, under maintenance, etc.

For example, an entity that (i) is running may be expected to be using in a range of 400 watts to 2000 watts, (ii) is idle may be expected to be using in the range of 200 watts to 399 watts, (iii) is paused may be expected to be using in the range of 100 watts to 199 watts, (iv) is stopped may be expected to be using in the range of 50 watts to 99 watts, and (v) is under maintenance may be expected to be using in the range of 0 watts to 49 watts. Ranges for labels included in edge device 100A status 206 may be adaptive to minimize a likelihood of assignment of the operational state that does not accurately reflect historic operation of the entity. The power consumption level of the entity of edge device 100A received by edge orchestrator 104 may include a measure of 450 watts. Therefore, the edge device 100A status 206 may be determined to be in a running state.

In addition to edge device 100A workload monitoring process 200, edge device 100B workload monitoring process 208 may be performed. During edge device 100B workload monitoring process 208, a second the at least one distribution agent of edge device 100B may measure a second power consumption level of the entities that perform the workload. The second the at least one distribution agent of edge device 100B may measure the second power consumption level in a likewise manner as the at least one distribution agent of edge device 100A measures the power consumption level.

Once the second power consumption level is obtained from a second weighted sum. The second weighted sum may be computed during edge device 100B workload monitoring process 208, similar to the weighted sum from edge device 100A workload monitoring process 200. The second power consumption level may be transferred to edge orchestrator 104. For example, at interaction 210, the second power consumption level of edge device 100B may be transferred to edge orchestrator 104. The second power consumption level of edge device 100B may be transferred via a data stream, message queues, an application programming interface (API), etc.

Once the second power consumption level is received by edge orchestrator 104, edge device 100B system determination process 212 may be performed. During edge device 100B system determination process 212, the second power consumption level may be used to edge device 100B status 214. To determine edge device 100B status 214, edge orchestrator 104 may compare the second power consumption level to the at least one threshold level. Depending on a magnitude of the second power consumption level, edge orchestrator 104 may determine if the entity of edge device 100B is running, idle, paused, stopped, under maintenance, etc.

Thus, via the data flow illustrated in FIG. 2A, a system in accordance with an embodiment may determine the status of the at least one edge device. Consequently, a deployment (e.g., 100) may be more likely to be able to provide desired computer implemented services by monitoring for a high-level indicator of an operational state of the at least one edge device.

Turning to FIG. 2B, a second interaction diagram in accordance with an embodiment is shown. The second interaction diagram may illustrate data used in and data processing performed in determining a health status of the at least one edge device.

To determine the health status of the at least one edge device, edge device 100A workload monitoring process 218 may be performed. During edge device 100A workload monitoring process 218, the at least one distribution agent of edge device 100A may measure a third power consumption level of the entities that perform the workload. The at least one distribution agent of edge device 100A may measure the third power consumption level in a likewise manner as the at least one distribution agent of edge device 100A measures the power consumption level during edge device 100A workload monitoring process 200.

Once the third power consumption level is obtained from a third weighted sum, the second power consumption level may be transferred to edge orchestrator 104. The third weighted sum may be computed during edge device 100A workload monitoring process 218, similar to the weighted sum from edge device 100A workload monitoring process 200. As an example of the transferring, at interaction 220, the third power consumption level of edge device 100A may be transferred to edge orchestrator 104. The third power consumption level of edge device 100A may be transferred via a data stream, message queues, an application programming interface (API), etc.

Once the third power consumption level is received by edge orchestrator 104, edge device 100A health determination process 222 may be performed. During edge device 100A health determination process 222, at least one previous power consumption level may be obtained from edge device 100A power usage repository 216. Edge device 100A power usage repository 216 may include the at least one previous power consumption level for edge device 100A.

The third power consumption level and/or the at least one previous power consumption level may be used to produce an average power consumption level. The average power consumption level may be produced by performing an arithmetic mean using the third power consumption level and the at least one previous power consumption level. From the arithmetic mean, an average power consumption level may be determined. The average power consumption level may not include transient changes in power consumption that may be present in third power consumption level and/or the at least one previous power consumption level.

During edge device 100A health determination process 222, the average power consumption level may be used to determined edge device 100A health status 224. The average power consumption level may be used by comparing the average power consumption level to at least a second threshold level. Depending on a magnitude of the power consumption level, edge orchestrator 104 may determine if the entity of edge device 100A is healthy, degraded, critical, unhealthy, etc.

For example, an entity that (i) is healthy may be expected to be consuming an average power in a range of 400 watts to 1000 watts, (ii) is degraded may be expected to be consuming the average power in the range of 200 watts to 399 watts, (iii) is critical may be expected to be consuming the average power in the range of 100 watts to 199 watts, and/or (iv) is unhealthy may be expected to be consuming the average power in the range of 0 watts to 99 watts. Ranges for labels included in edge device 100A health status 224 may be adaptive to minimize a likelihood of assignment of the operational state that does not accurately reflect historic operation of the entity. The average power consumption level of the entity of edge device 100A received by edge orchestrator 104 may include a measure of 399 watts. Therefore, the edge device 100A status 206 may be determined to be in a degraded state.

Thus, via the data flow illustrated in FIG. 2B, a system in accordance with an embodiment may determine the health status of the at least one edge device. Consequently, a deployment (e.g., 100) may be more likely to be able to provide desired computer implemented services by monitoring for an indicator of a health state of the at least one edge device.

Turning to FIG. 2C, a third interaction diagram in accordance with an embodiment is shown. The third interaction diagram may illustrate data used in and data processing performed in determining a security status of the at least one edge device.

To determine the security status of the at least one edge device, edge device 100A workload monitoring process 226 may be performed. During edge device 100A workload monitoring process 226, the at least one distribution agent of edge device 100A may measure a fourth power consumption level of the entities that perform the workload. The at least one distribution agent of edge device 100A may measure the fourth power consumption level in a likewise manner as the at least one distribution agent of edge device 100A measures the power consumption level during edge device 100A workload monitoring process 200.

Once the fourth power consumption level is obtained from the weighted sum, the fourth power consumption level may be transferred to edge orchestrator 104. The fourth weighted sum may be computed during edge device 100A workload monitoring process 226, similar to the weighted sum from edge device 100A workload monitoring process 200.As an example of the transferring, at interaction 228, the fourth power consumption level of edge device 100A may be transferred to edge orchestrator 104. The fourth power consumption level of edge device 100A may be transferred via a data stream, message queues, an application programming interface (API), etc.

Once the fourth power consumption level is received by edge orchestrator 104, edge device 100A vulnerability assessment process 230 may be performed. During edge device 100A vulnerability assessment process 230, at least one security status may be defined: secure (e.g., no known vulnerabilities), at risk (e.g., potential vulnerabilities exist in the edge device), breached (e.g., the edge device has been compromised), and/or mitigating (e.g., the edge device is responding to at least one vulnerability).

During edge device 100A vulnerability assessment process 230, a second at least one previous power consumption level may be obtained from edge device 100A power usage repository 216. Edge device 100A power usage repository 216 may include the second the at least one previous power consumption level for edge device 100A.

The fourth power consumption level and/or the second the at least one previous power consumption level may be used to produce a second average power consumption level. The second average power consumption level may be produced by performing an arithmetic mean using the fourth power consumption level and the second the at least one previous power consumption level. From the arithmetic mean, the second average power consumption level may be determined. The second average power consumption level may not include the transient changes in the power consumption that may be present in the fourth power consumption level and/or the second the at least one previous power consumption level.

During edge device 100A vulnerability assessment process 230, edge device 100A health state 224 may be ingested. Edge device 100A health state 224 and the second average power consumption level may be used to determine edge device 100A security state 232. Edge device 100A health state 224 and the second average power consumption level may be used by mapping edge device 100A health state 224 and the second average power consumption level to at least one of a security status (secure, at risk, breached, mitigating, etc.).

For example, a security status with a label of secure may be expected to have a health state label of healthy and the second average power consumption level to be within a normal range (e.g., 400 watts to 1000 watts). Also, the security status with the label of at risk may be expected to have the health state of degraded and the second average power consumption level to be within a high range (e.g. above 1000 watts). Finally, the security status with the label of breached and/or mitigating may be expected to have the health state of unhealthy and the second average power consumption level to be within a low range (e.g. 0 watts to 50 watts).

Thus, via the data flow illustrated in FIG. 2C, a system in accordance with an embodiment may determine the security status of the at least one edge device. Consequently, a deployment (e.g., 100) may be more likely to be able to provide desired computer implemented services by monitoring for a second indicator of a security state of the at least one edge device.

Turning to FIG. 2D, a fourth interaction diagram in accordance with an embodiment is shown. The fourth interaction diagram may illustrate data used in and data processing performed in performing a scaling of a workload of the at least one edge device.

To perform the scaling of the workload, edge device 100A power optimization process 236 may be performed. During edge device 100A power optimization process 236, edge orchestrator 104 may obtain at least a third the at least one previous power consumption level for edge device 100A. The third the at least one previous power consumption level may be obtained from edge device 100A power usage repository 216.

Using the third the at least one previous power consumption level, a historical power analysis of edge device 100A may be performed. The historical power analysis may be performed by obtaining at least one pattern of historical power consumption by edge device 100A. For example, the historical power analysis may track the power consumption of edge device 100A that increases from 400 watts to 800 watts. Further the power consumption of 800 watts by edge device 100A may fluctuate between 400 watts and 800 watts to a present time.

Edge orchestrator 104 may determine that fluctuations of power consumption by edge device 100A may be indicative of, for example, polymorphic malware in at least one entity of edge device 100A. To mitigate an effect of the polymorphic malware in at least one entity of edge device 100A, edge orchestrator 104 may establish a threshold of power consumption to be set at, for example, 400 watts for the at least one entity. A predictive model may be used by edge orchestrator 104 to perform a predictive analysis of an effect of the threshold on the at least one entity in a sandboxed operation. The predictive analysis may include a summary of the effect of the threshold on the at least one entity of edge device 100A.

If the summary of the effect of the threshold includes an optimization in performance of the at least one entity of edge device 100A, then at least one parameter used to set the threshold may be transferred (e.g., interaction 238) to edge device 100A. The at least one parameter may be transferred may via a data stream, message queues, an application programming interface (API), etc.

Once the at least one parameter is received, edge device 100A workload scaling process 240 may be performed. During edge device 100A workload scaling process 240, the at least one parameter may be applied to operation of the at least one entity. The at least one parameter may be applied by ingesting, by the at least one entity, the at least one parameter to modify the operation. Ingesting the at least one parameter may scale the operation of the at least one entity. The scaling may include (i) constraining operation of a portion of edge device 100A, (ii) reinitializing the operation of the portion of edge device 100A, and/or (iii) disabling use services of the portion of edge device 100A.

Thus, via the data flow illustrated in FIG. 2D, a system in accordance with an embodiment may scale of the workload of the at least one edge device. Consequently, a deployment (e.g., 100) may be more likely to be able to provide desired computer implemented services by optimizing performance of the at least one edge device to improve a provision of computer implemented services.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

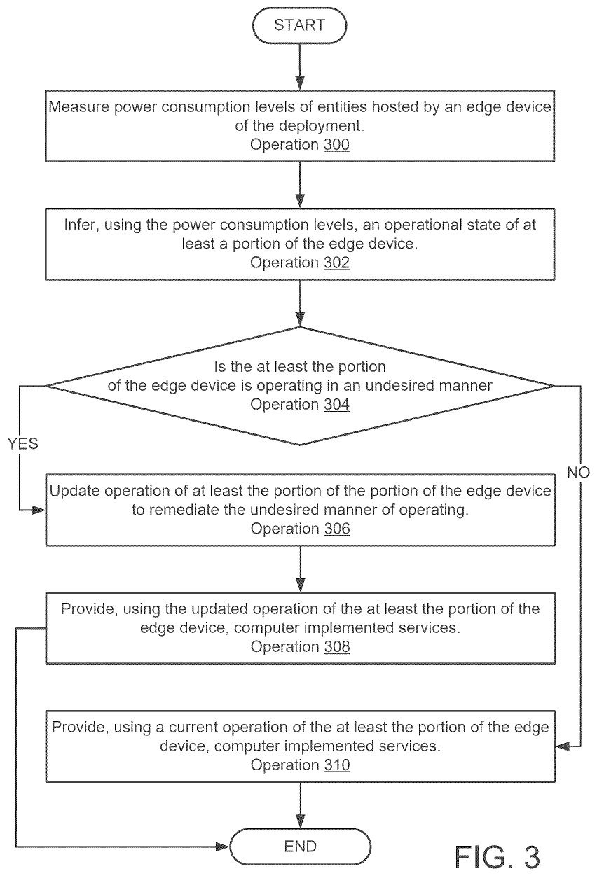

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location. As discussed above, the components of FIG. 1 may perform various methods to manage data processing systems. FIG. 3 illustrates a method that may be performed by the components of the system of FIG. 1. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of managing operation of a deployment in accordance with an embodiment is shown. The method may be performed, for example, by any of the components of the system of FIG. 1, and/or other components not shown therein.

At operation 300, power consumption levels of entities hosted by an edge device of the deployment may be measured. The power consumption levels may be measured, for an entity of the entities, by (i) obtaining at least a central processing unit usage of the entity, (ii) obtaining at least a memory usage of the entity, (iii) obtaining at least a network traffic usage of the entity, and (iv) obtaining, using the at least the central processing unit usage, the at least the memory usage, and the at least the network traffic usage, a power consumption level of the power consumption levels for the entity.

The central processing unit usage may be obtained by performing a lookup for the central processing unit usage in a system monitoring tool of the edge device. The memory usage may be obtained by performing a lookup for the memory usage in the system monitoring tool of the edge device. The network traffic usage may be obtained by performing a lookup for the network traffic usage in a network monitoring tool of the edge device.

The power consumption level may be obtained by obtaining a weighted sum of the at least the central processing unit usage, the at least the memory usage, and the at least the network traffic usage. The weighted sum may be obtained by performing a summation of at least three products: (i) a product of the central processing unit usage and a power consumption relative to the central processing unit usage, (ii) the product of the memory usage and the power consumption relative to the memory usage, and (iii) the product of the network traffic usage and the power consumption relative to the network usage.

At operation 302, an operational state of at least a portion of the edge device may be inferred using the power consumption levels. The operational state may be inferred, for an entity of the entities, by (i) comparing the power consumption level to a nominal power consumption level for a type of the entity and (ii) concluding that the entity is in an undesired operating state, in an instance of the comparing where the power consumption level and the nominal power consumption level different by a threshold level.

The power consumption level may be compared to the nominal power consumption level by measuring whether the power consumption level is different from the nominal power consumption level by the threshold level. The entity may be concluded to be in the undesired operating state by determining that the power consumption level is different from the nominal power consumption level by the threshold level.

At operation 304, a determination may need to be made regarding whether the operational state indicates that the at least the portion of the edge device is operating in an undesired manner. The determination may be made by using the power consumption levels to assess a health state and/or a security state of the portion of the edge device. If the operational state indicates that the at least the portion of the edge device is operating in an undesired manner, then the method may continue at operation 306. Otherwise, if the operational state indicates that the at least the portion of the edge device is not operating in an undesired manner, then the method may continue at operation 310.

At operation 306, operation of at least the portion of the portion of the edge device may be updated to remediate the undesired manner of operating. The operation may be updated by scaling the portion of the portion of the edge device.

At operation 308, computer implemented services may be provided using the updated operation of the at least the portion of the edge device. The computer implemented services may be provided by performing, by the at least the portion of the edge device, a workload.

Continuing from operation 304, at operation 310, the computer implemented services may be provided using a current operation of the at least the portion of the edge device. The computer implemented services may be provided by performing, by the at least the portion of the edge device, the workload without scaling the portion of the portion of the edge device.

Thus, via the method shown in FIG. 3, embodiments herein may likely improve a likelihood of managing the operation of the deployment. By improving the likelihood of managing the operation of the deployment, the data processing systems may be more likely to provide desirable computer implemented services by, for example, hardening the configuration of the blueprint using validation steps, monitoring power consumption levels to determine an operational state, health state, and/or security state of the edge device, scaling performance of a workload by the edge device based on the monitoring of the power consumption levels, etc.

Any of the components illustrated in FIGS. 1-2D may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a deployment, the method comprising:
measuring power consumption levels of entities hosted by an edge device of the deployment;
inferring, using the power consumption levels, an operational state of at least a portion of the edge device;
making a determination regarding whether the operational state indicates that the at least the portion of the edge device is operating in an undesired manner;
in a first instance of the determination where the at least the portion of the edge device is operating in the undesired manner:
updating operation of at least the portion of the portion of the edge device to remediate the undesired manner of operating; and
providing, using the updated operation of the at least the portion of the edge device, computer implemented services.

2. The method of claim 1, wherein measuring the power consumption levels of the entities comprises:
for an entity of the entities:
obtaining at least a central processing unit usage of the entity;
obtaining at least a memory usage of the entity;
obtaining at least a network traffic usage of the entity; and
obtaining, using the at least the central processing unit usage, the at least the memory usage, and the at least the network traffic usage, a power consumption level of the power consumption levels for the entity.

3. The method of claim 2, wherein obtaining the power consumption level comprises:
obtaining a weighted sum of the at least the central processing unit usage, the at least the memory usage, and the at least the network traffic usage.

4. The method of claim 1, wherein inferring, using the power consumption levels, the operational state of the at least the portion of the edge device comprises:
for the entity of the entities:
comparing the power consumption level to a nominal power consumption level for a type of the entity; and
in an instance of the comparing where the power consumption level and the nominal power consumption level different by a threshold level: concluding that the entity is in an undesired operating state.

5. The method of claim 4, wherein the nominal power consumption level is based on an average of power consumption levels from a cohort of entities that are of the type of the entity over a period of time.

6. The method of claim 4, wherein the power consumption level is averaged over a duration of time to reduce impacts of transient changes in the power consumption level.

7. The method of claim 6, wherein the nominal power consumption level is adaptive to minimize a likelihood of assignment of the operational state that does not accurately reflect historic operation of the entity.

8. The method of claim 1, wherein updating the operation of the at least the portion of the portion of the edge device to remediate the undesired manner of operating comprises:
constraining operation of the at least the portion of the portion of the edge device.

9. The method of claim 1, wherein updating the operation of the at least the portion of the portion of the edge device to remediate the undesired manner of operating comprises:
reinitializing the at least the portion of the portion of the edge device.

10. The method of claim 1, wherein updating the operation of the at least the portion of the portion of the edge device to remediate the undesired manner of operating comprises:
disabling use services provided by the at least the portion of the portion of the edge device.

11. A non-transitory machine-readable medium having instructions stored therein, which when executed by a processor, cause the processor to perform operations for managing operation of a deployment, the operations comprising:
measuring power consumption levels of entities hosted by an edge device of the deployment;
inferring, using the power consumption levels, an operational state of at least a portion of the edge device;
making a determination regarding whether the operational state indicates that the at least the portion of the edge device is operating in an undesired manner;
in a first instance of the determination where the at least the portion of the edge device is operating in the undesired manner:
updating operation of at least the portion of the portion of the edge device to remediate the undesired manner of operating; and
providing, using the updated operation of the at least the portion of the edge device, computer implemented services.

12. The non-transitory machine-readable medium of claim 11, wherein measuring the power consumption levels of the entities comprises:
for an entity of the entities:
obtaining at least a central processing unit usage of the entity;
obtaining at least a memory usage of the entity;
obtaining at least a network traffic usage of the entity; and
obtaining, using the at least the central processing unit usage, the at least the memory usage, and the at least the network traffic usage, a power consumption level of the power consumption levels for the entity.

13. The non-transitory machine-readable medium of claim 12, wherein obtaining the power consumption level comprises:
obtaining a weighted sum of the at least the central processing unit usage, the at least the memory usage, and the at least the network traffic usage.

14. The non-transitory machine-readable medium of claim 11, wherein inferring, using the power consumption levels, the operational state of the at least the portion of the edge device comprises:
for the entity of the entities:
comparing the power consumption level to a nominal power consumption level for a type of the entity; and
in an instance of the comparing where the power consumption level and the nominal power consumption level different by a threshold level:
concluding that the entity is in an undesired operating state.

15. The non-transitory machine-readable medium of claim 14, wherein the nominal power consumption level is based on an average of power consumption levels from a cohort of entities that are of the type of the entity over a period of time.

16. A data processing system, comprising:
a processor; and
a memory coupled to the processor to store instructions, which when executed by the processor, cause the processor to perform operations managing operation of a deployment, the operations comprising:
measuring power consumption levels of entities hosted by an edge device of the deployment;
inferring, using the power consumption levels, an operational state of at least a portion of the edge device;
making a determination regarding whether the operational state indicates that the at least the portion of the edge device is operating in an undesired manner;
in a first instance of the determination where the at least the portion of the edge device is operating in the undesired manner:
updating operation of at least the portion of the portion of the edge device to remediate the undesired manner of operating; and
providing, using the updated operation of the at least the portion of the edge device, computer implemented services.

17. The data processing system of claim 16, wherein measuring the power consumption levels of the entities comprises:
for an entity of the entities:
obtaining at least a central processing unit usage of the entity;
obtaining at least a memory usage of the entity;
obtaining at least a network traffic usage of the entity; and
obtaining, using the at least the central processing unit usage, the at least the memory usage, and the at least the network traffic usage, a power consumption level of the power consumption levels for the entity.

18. The data processing system of claim 17, wherein obtaining the power consumption level comprises:
obtaining a weighted sum of the at least the central processing unit usage, the at least the memory usage, and the at least the network traffic usage.

19. The data processing system of claim 16, wherein inferring, using the power consumption levels, the operational state of the at least the portion of the edge device comprises:
for the entity of the entities:
comparing the power consumption level to a nominal power consumption level for a type of the entity; and
in an instance of the comparing where the power consumption level and the nominal power consumption level different by a threshold level:
concluding that the entity is in an undesired operating state.

20. The data processing system of claim 19, wherein the nominal power consumption level is based on an average of power consumption levels from a cohort of entities that are of the type of the entity over a period of time.
